(19) United States
(12) Patent Application Publication
(10) Pub. No.: US 2026/0266304 A1
(43) Pub. Date: Sep. 10, 2026

(54) Systems and Methods for Thermal Spraying of Protective Materials onto Composite Laminates

(71) Applicant: Supernal, LLC, Irvine, CA (US)

(72) Inventor: Bryan Marshall, Irvine, CA (US)

(21) Appl. No.: 19/167,013

(22) PCT Filed: May 8, 2024
(86) PCT No.: PCT/US2024/028411

§ 371 Date: Sep. 19, 2025

Related U.S. Application Data
(60) Provisional application No. 63/465,195, filed on May 9, 2023.

(51) Int. Cl. F04D 29/02; B25J 11/00; C23C 4/08; C23C 4/18

(52) U.S. Cl. CPC F04D 29/023; B25J 11/0075; C23C 4/08; C23C 4/18

(57) ABSTRACT

A method is disclosed. The method includes determining one or more parameters for depositing a material, using a thermal sprayer, onto each of a plurality of composite laminate structures. The method also includes depositing a first layer of the material onto a surface of each of the plurality of composite laminate structures. The method further includes cooling the plurality of composite laminate structures. The method additionally includes depositing a second layer of the material onto the first layer of material on each of the plurality of composite laminate structures. The method also includes determining a remaining number of layers of the material to deposit and a deposition location for each of the remaining layers of the material. The method includes depositing the determined remaining number of layers of the material at the determined deposition location on each of the plurality of composite laminate structures.

### CROSS REFERENCE TO RELATED APPLICATION

The present application claims priority to U.S. Provisional Application No. 63/465,195, filed on May 9, 2023, the entire contents of which are herein incorporated by reference as if fully set forth in this description.

### BACKGROUND

Rotor aircraft utilize a variety of materials, such as composite laminates, for the propeller/rotor blades. Because rotor aircraft operate across numerous environments, the propeller/rotor blades may be exposed to a multitude of deleterious conditions, such as rain, ice, saltwater, sand, and/or dust. Such deleterious conditions may cause damage to the propeller/rotor blades. Erosion may be one form of damage commonly experienced by propeller/rotor blades operating in such conditions.

To mitigate erosion to the propeller/rotor blades, the leading edge of the blade may utilize a protective shield, such as a metallic material. Current methods of producing protective shields for propeller/rotor blades involve electroforming, stretch forming, and/or hot creep forming. Typically the protective shield may be manufactured then bonded after manufacturing to the leading edge of the blade. After installation (e.g., bonding) of the protective shield the blade may be weighed and balanced. Careful weighing and balancing of the blades may be performed to mitigate vibration.

The current methods of producing protective shields may be slow and not allow for adequate production scalability. Moreover, the current methods may have limited repairability options. For example, when the protective shield experiences damage and/or wear, the entire protective shield may require removal and replacement from the propeller blade. This may increase cost and downtime of the blade associated with being out of operation. Additionally, removal of the protective shield may cause damage to the structure of the propeller/rotor blade. The high cost and/or damage experienced from replacing the protecting shield may result in scrapping the blade altogether. Thus, there is a need for a method of manufacturing repairable protective shields for propeller blades that offer production scalability.

Accordingly, the present invention seeks to produce a protective shield that may be repairable and scalable.

### SUMMARY

Embodiments described herein relate to applying materials onto a composite laminate, such as a rotor blade, and more particularly, to systems, methods, and devices for thermal spraying of protective materials onto composite laminates.

In a first example embodiment, a method is provided. The method includes determining one or more parameters for depositing a material, using a thermal sprayer, onto each of a plurality of composite laminate structures. The method also includes depositing, using the thermal sprayer, a first layer of the material onto a surface of each of the plurality of composite laminate structures. The method further includes cooling, subsequent to depositing the first layer of the material, the plurality of composite laminate structures. The method additionally includes depositing, using the thermal sprayer, a second layer of the material onto the first layer of material on each of the plurality of composite laminate structures. The method also includes cooling, subsequent to depositing the second layer of the material, the plurality of composite laminate structures. The method also includes determining, for each of the plurality of composite laminate structures, (i) a remaining number of layers of the material to deposit and (ii) a deposition location for each of the remaining layers of the material. The method also includes depositing, using the thermal sprayer, the determined remaining number of layers of the material at the determined deposition location on each of the plurality of composite laminate structures.

In some examples, the plurality of composite laminate structures are rotor blades.

In some examples, a portion of each of the plurality of rotor blades comprises a bond promoting layer.

In some examples, determining, for each of the plurality of composite laminate structures, (i) the remaining number of layers of the material to deposit and (ii) the deposition location for each of the remaining layers of the material is based on a weight and a spanwise weight distribution of each of the plurality of composite laminate structures.

In some examples, each of the determined remaining number of layers of material is sequentially deposited onto each of the plurality of composite laminate structures.

In some examples, depositing, using the thermal sprayer, the determined remaining number of layers of the material at the determined deposition location on each of the plurality of composite laminate structures further includes cooling each of the composite laminate structures between depositing each of the determined remaining number of layers.

In some examples, the plurality of composite laminate structures are fan blades for a turboprop engine.

In some examples, determining the one or more parameters for depositing the material further includes examining, using a three-dimensional digital scan, existing deposited material on at least one of the plurality of composite laminate structures.

In some examples, the thermal sprayer is coupled to a robot, and depositing the first layer of the material includes directing the thermal sprayer, using the robot, along a determined deposition location of each of the plurality of composite laminate structures.

In some examples, the deposition location of at least one of the remaining layers of material is different than a deposition location of the first layer.

In some examples, a thickness of deposited material at a first location on each of the plurality of composite laminate structures is different than a thickness of deposited material at a second location.

In some examples, depositing the first layer of material onto the surface of each of the plurality of composite laminate structures further includes: depositing the first layer of material onto the surface of a first composite laminate structure; and subsequent depositing the first layer of material onto the surface of a first composite laminate structure to the first composite laminate structure, depositing the first layer of material onto the surface of a second composite laminate structure.

In some examples, cooling the plurality of composite laminate structures further includes cooling the first composite laminate structure during deposition of the first layer onto the second composite laminate structure.

In some examples, the plurality of composite laminate structures are mounted on a rack or a carousel.

In some examples, each of the plurality of composite laminate structures is assigned a unique identifier and the method further includes associating, for each of the plurality of composite laminate structures, (i) the determined remaining number of layers of material to deposit and (ii) the determined the deposition location for each of the remaining layers of the material with the unique identifier.

In some examples, depositing the first layer of material includes depositing a material including at least 90 percent nickel in direct communication with a surface of the composite laminate structure.

In some examples, the remaining number of layers of the material to deposit on a first composite laminate structure is different than the remaining number of layers of the material to deposit on a second composite laminate structure.

In a second example embodiment, a non-transitory computer readable medium includes program instructions executable by one or more processors to perform the operations including: determining one or more parameters for depositing a material, using a thermal sprayer, onto each of a plurality of composite laminate structures. The operations also include depositing, using the thermal sprayer, a first layer of the material onto a surface of each of the plurality of composite laminate structures. The operations further include cooling, subsequent to depositing the first layer of the material, the plurality of composite laminate structures. The operations additionally include depositing, using the thermal sprayer, a second layer of the material onto the first layer of material on each of the plurality of composite laminate structures. The operations also include cooling, subsequent to depositing the second layer of the material, the plurality of composite laminate structures. The operations also include determining, for each of the plurality of composite laminate structures, (i) a remaining number of layers of the material to deposit and (ii) a deposition location for each of the remaining layers of the material. The operations also include depositing, using the thermal sprayer, the determined remaining number of layers of the material at the determined deposition location on each of the plurality of composite laminate structures.

In a third example embodiment a rotor blade is provided. The rotor blade includes a composite laminate structure; and a protective material comprising at least 90 percent nickel in direct communication with a surface of the composite laminate structure and disposed along a leading edge of the rotor blade, the protective material having a non-constant thickness.

In a fourth example embodiment a robot for thermally spraying material onto composite laminate structures is provided. The robot includes a thermal sprayer; and a controller operably connected to the robot and configured to cause the robot to selectively deposit, using the thermal sprayer, one or more layers of a material onto a specified location on each of a plurality of composite laminate structures.

These as well as other aspects, advantages, and alternatives will become apparent to those of ordinary skill in the art by reading the following detailed description, with reference, where appropriate, to the accompanying drawings.

### BRIEF DESCRIPTION OF THE DRAWINGS

FIG. 1 is a perspective view of a rotor blade, according to exemplary embodiments of the present invention.

FIGS. 2A-2B are perspective views of a rotor blade including a protective material, according to exemplary embodiments of the present invention.

FIG. 3 is a robot for depositing protective material onto rotor blades, according to exemplary embodiments of the present invention.

FIG. 4 is a cross-sectional view of a portion of a rotor blade, according to exemplary embodiments of the present invention.

FIGS. 5A-5C are cross-sectional portions of a rotor blade showing a protective material at different stages of processing, according to exemplary embodiments of the present invention.

FIG. 6 is a flow chart of an example method for adding protective material to a composite laminate, according to exemplary embodiments of the present invention.

FIG. 7 is a simplified block diagram showing some of the components of an example computing device, according to an exemplary embodiment of the present disclosure.

FIG. 8 is a simplified block diagram showing the example computing device coupled to a robot and a plurality of rotor blades; according to exemplary embodiments of the present invention.

### DETAILED DESCRIPTION

Disclosed herein are examples describing various features and functions of the disclosed apparatus, processes, and methods with reference to the accompanying figures. The figures are not necessarily to scale and sizes of the various elements may be distorted for clarity. It is understood that various aspects of the disclosed apparatus, processes, and methods can be arranged and combined in a wide variety of different configurations, all of which are contemplated herein. The disclosure generally relates to thermal spraying of protective materials onto a composite laminate.

The present application is directed to processes, techniques, and materials for additive manufacturing of protective materials (e.g., an erosion resistant material) to a structure, such as a leading edge of a rotor blade. In some embodiments, the rotor blade may be part of a vehicle. In some embodiments, the vehicle may be a VTOL, which may or may not use propellers to hover, takeoff, and/or land. It should be understood that in other embodiments, the vehicle may be any other type of vehicle that may be able to utilize the advantages of the present invention, such as a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, or a drone). In some embodiments, the vehicle may include a turboprop engine, and the processes, techniques, and materials for additive manufacturing of protective materials described herein may be applied to a first stage fan of the turboprop engine.

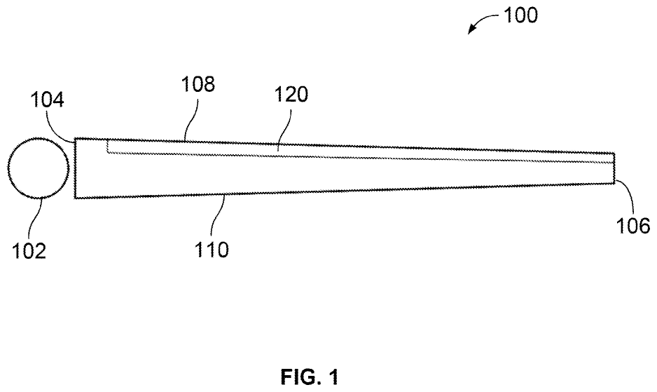

In some embodiments, the vehicle may include one or more propellers used to drive the vehicle. The one or more propellers may each comprise a plurality of rotor blades, such as rotor blade 100 described below with respect to FIG. 1. The rotor blade 100 may comprise a composite laminate, and may or may not have a cross-sectional airfoil shape. Each propeller may be configured, for example, as tiltrotors, lift rotors, or any other type of rotors. In other embodiments, the vehicle may include one or more turbine engines, one or more tires, one or more ski-structures, or the like instead of the one or more propellers used to drive the vehicle.

FIG. 1 is a perspective view of a rotor blade 100, according to exemplary embodiments of the present invention. The rotor blade 100 may include a root 104 attached to a rotor hub 102, a tip 106 opposite the root 104, a leading edge 108 having a protective material 120, and a trailing edge 110 opposite the leading edge 108. The rotor blade 100 may rotate clockwise or counterclockwise about the rotor hub 102. The rotor blade 100 may comprise any suitable material, for example a composite laminate, and may vary in cross-section thickness from the leading edge 108 to the trailing edge 110, and/or vary in thickness along a length spanning from the root 104 to the tip 106.

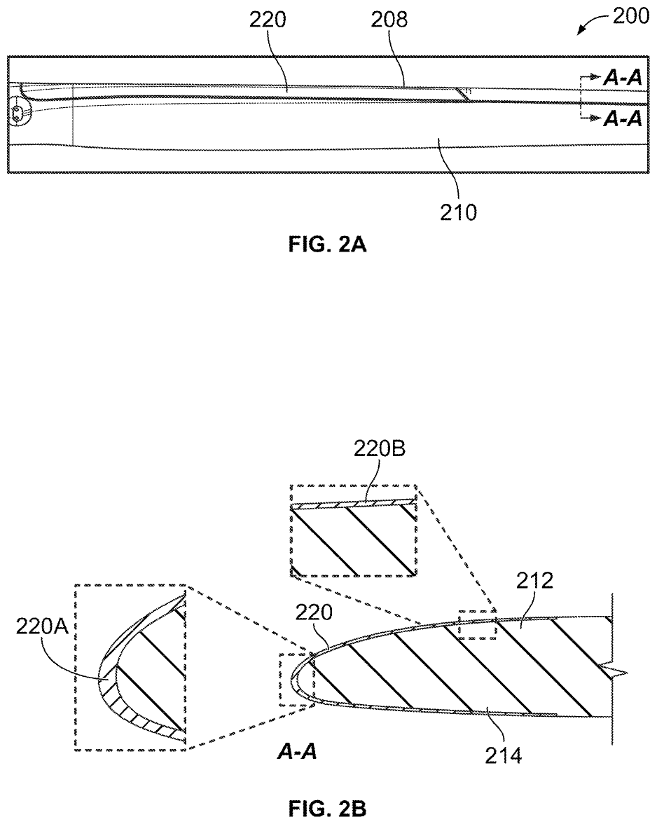

FIGS. 2A-2B are perspective views of a rotor blade 200 including a protective material 220, according to exemplary embodiments of the present invention. FIG. 2B illustrates cross-section A-A shown in FIG. 2A. The rotor blade 200 includes a leading edge 208, an aft body 210, an upper contour 212, a lower contour 214, and the protective material 220. The protective material 220 may be disposed along the leading edge 208 of the rotor blade 200 and extend a distance along a longitudinal length of the rotor blade 200. The protective material 220 may extend a distance, such as a percentage chord length (e.g., 25%±3% chord length), of the rotor blade 200 from the leading edge 208 through the aft body 210 (e.g., upper and/or lower contour). Thus, in rotor blades having a cross-sectional airfoil shape, such as the rotor blade 200, the protective material 220 may be disposed on the leading edge 208, the aft body 210, the upper contour 212 (e.g., upper surface), and/or the lower contour 214 (e.g., lower surface).

As illustrated in FIGS. 2A-2B, a thickness of the protective material 220 may vary across a respective cross-section of the rotor blade 200. The thickness of the protective material 220 at the leading edge 208 may be greater than the thickness of the protective material 220 at a distance from the leading edge 208. For example, a thickness 220A of the protective material 220 at the leading edge 208 may be greater than a thickness 220B of the protective material 220 on the upper contour 212 and/or the lower contour 214. In some embodiments, the thickness of the protective material 220 at a location on the rotor blade 200 may be based on expected wear (e.g., erosion) at the respective location. Similarly, the thickness of the protective material 220 may vary in thickness along the longitudinal length of the rotor blade 200, such as a length spanning from a root of a rotor blade 200 to a tip of the rotor blade 200. Thus, the thickness of the protective material 220 may be greater at locations where the rotor blade 200 may be expected to experience increased erosive effects, for instance at the leading edge 208 or at a tip. However, in other embodiments, the thickness of the protective material 220 may be constant at the respective cross-section.

The protective material 220 may be made from any suitable material, such as a single metal or metal alloy, a plurality of metals or metal alloys, a single ceramic material, a combination of ceramic materials, and/or a combination of single or multiple ceramic materials and single or multiple metals including metal alloys. For example, the protective material 220 may comprise aluminum, aluminum alloys, tungsten, tungsten alloys, cobalt, cobalt alloys, nickel, nickel alloys, chrome, chrome alloys, molybdenum, molybdenum alloys, iron alloys, zinc, zinc alloys, combinations of metals and/or metal alloys, carbides combined with metals and/or metal alloys, nickel-chromium-aluminum, chromium-oxide, alumina-titania, aluminum-oxide, chromium-carbide, tungsten-carbide, tungsten-carbide-nickel, etc. In embodiments, the protective material 220 may be selected to provide the rotor blade 200 with an erosion resistant leading edge protection appropriate for operation in rain and/or sand.

In one embodiment, the protective material 220 may be a nickel alloy comprising approximately 95% nickel. However, in other embodiments, the nickel alloy may comprise between 90% to 92% nickel, between 92% to 94% nickel, between 94% to 96% nickel, between 96% to 98% nickel, and between 98% to 99% nickel.

Within embodiments, the protective material 220 may be applied in any suitable manner. For example, the protective material 220 may be applied by a thermal spraying process, described in more detail below. In some embodiments, the protective material 220 may be applied directly to a surface of the rotor blade 200, while in other embodiments a bond promoting layer, such as a seed layer and/or a cold sprayed metallic particle layer may be applied to the rotor blade 200 prior to application of the protective material 220. For example, the seed layer may be a metallic particle impregnated resin and/or a metallic prepreg.

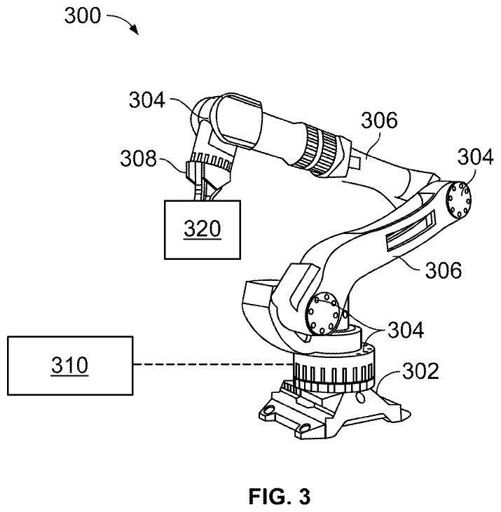

FIG. 3 is a robot 300 for depositing protective material onto rotor blades, according to exemplary embodiments of the present invention. The robot 300 may include a base 302, one or more arms 306 having one or more joints 304 movable in six degrees of freedom, and a head 308 coupled to a thermal sprayer 320. The arm 306, together with the joint 304, may allow the robot 300 to position the thermal sprayer 320 over a selected area of the work piece. In one embodiment, the work piece may be the rotor blade of FIG. 1. In some embodiments, such as the embodiment shown, the robot 300 may be coupled to a controller 310 configured to control operations of the robot 300. For example, the controller 310 may cause the thermal sprayer 320, coupled to the head 308 to deposit protective material, such as a nickel alloy, onto a portion of the rotor blade.

Within embodiments, a rotor blade may be placed in a chamber for processing by the robot 300. The robot 300 may use the thermal sprayer 320 to deposit a layer of protective material onto a desired portion of the rotor blade. In some embodiments, the thermal sprayer 320 may spray the protective coating directly onto the rotor blade; however in other embodiments, a pre-coat, such as a cold sprayed metallic powder, may be applied prior to thermal spraying to promote bonding of the protective coating to the rotor blades. In embodiments, more than one layer of protective material may be applied to the rotor blade. For example, the robot 300 may apply one or more layers, ten or more layers, twenty or more layers, and/or thirty or more layers of protective material to the desired portion of the rotor blade via the thermal sprayer 320. In some embodiments, the thickness of each applied layer of protective material may be constant, while in other embodiments the thickness of each applied layer of protective material may be different. Each applied layer of protective material may be between 0.001 inch to 0.003 inch, between 0.003 inch to 0.006 inch, between 0.006 inch to 0.009 inch, and/or between 0.009 inch to 0.012 inch.

Within embodiments, the robot 300 may process one or more work pieces at a time, such as one or more rotor blades. For example, the robot 300 may process between one to ten rotor blades at a time, between ten to twenty rotor blades at a time, between twenty to thirty rotor blades at a time, between thirty to forty rotor blades at a time, between forty and fifty rotor blades at a time, between fifty and sixty rotor blades at a time. In processing the one or more rotor blades, the robot 300 may apply a first layer of protective material to each of the rotor blades being processed, before applying a second layer of protective material to each of the rotor blades being processed. The robot 300 may repeat this for each successive layer of protective material applied. For example, the robot 300 may apply the first layer of protective material to a desired portion of a first rotor blade, then the robot may move to a next (e.g., a second, a third, a fourth, an nth.) rotor blade to apply the first layer of protective material to a desired portion of the second rotor blade. Once each rotor blade in the processing batch has received the respective layer, such as the first layer, the robot 300 may then begin applying a subsequent layer to each of the respective rotor blades. In some embodiments, the rotor blades may undergo pre-processing, such as a solvent treatment, prior to receiving the first layer.

Thermal spraying protective material may cause the substrate (e.g., the rotor blade) to increase in temperature. Temperature increase in the rotor blades during processing may be undesirable, as it may have an adverse impact on a material property of the rotor blades. Thus, applying a respective layer to each of the respective rotor blades before applying the subsequent layer may allow time for each respective rotor blade to cool to a desired temperature before the subsequent layer may be deposited. This may mitigate material properties in the rotor blades from becoming adversely affected by processing temperature. Further, this may allow for processing of multiple rotor blades at once (e.g., batch processing).

In some embodiments, to allow for multiple batch processing, the rotor blades may be placed on a rotatable frame, carrousel, stand, and/or other fixture. The fixture may allow for the desired rotor blade to be placed in front of the robot 300 having the thermal sprayer 320. The robot 300 may then be controlled by the controller 310 to apply the protective material, using the thermal sprayer 320, to desired portions of the rotor blade. For example, when the first rotor blade receives the respective layer of protective material from the thermal sprayer 320, the fixture may rotate and/or move to present the robot 300 with the second, and/or subsequent, rotor blade to receive the respective layer of protective material from the thermal sprayer 320. In other embodiments, however, the rotor blades may be placed on a static fixture and the robot 300 may be controlled to position itself in front of the desired rotor blade for processing by the thermal sprayer 320. Within embodiments, a unique identifier may be assigned to each rotor blade. Processing data may be associated with the unique identifier and stored in a data storage for access by the robot 300. For example, the processing data may include information about the processing parameters, such as a temperature, a spray angle, a material deposition thickness, a spray velocity, a number of layers applied, and/or a location on the rotor blade where protective material may be applied. In some embodiments, the controller 310 may access the processing data for use in directing the robot 300 during processing.

In some embodiments, the rotor blades may be weighed prior to application of all desired layers of protective material. For example, the rotor blades may be weighed when between 50% and 60% of the layers have been applied, when between 60% and 70% of the layers have been applied, when between 70% and 80% of the layers have been applied, when between 80% and 90% of the layers have been applied, and/or when between 90% and 100% of the layers have been applied. Within embodiments, the rotor blades may be weighed one or more times. The weighing may be used to determine a center of gravity and/or a span balance moment for each respective rotor blade. The weight information, calculated center of gravity, and/or calculated span balance moment may be compared against data from a master rotor blade, such as a properly balanced rotor blade. This may be used to determine the deposition location and/or the remaining number of layers to be applied to the respective rotor blade in order to properly balance each rotor blade.

In some embodiments, the rotor blades may be weighed while still on the fixture. For example, the fixture may comprise one or more sensors configured to gather weight information for each of the rotor blades. For instance, each of the rotor blades may be coupled to one or more of the sensors. The one or more sensors may be set to gather weight information continuously or at determined periods. The one or more sensors may be communicatively coupled to a computer device and may transmit the data (e.g., weight information) to the computer device for processing. In some embodiments, a second robot may be controlled during processing to remove each of the rotor blades in the batch and place each of the rotor blades onto a sensor configured to gather weight information. After the weight information has been gathered, the robot may be controlled to place the rotor blade back into the fixture. Thus, weight information of the rotor blades may generated without the need to remove the rotor blades from processing. However, in other embodiments, the rotor blades may be removed during processing to gather weight information.

The data generated from the weight information, such as the determined center of gravity and/or determined span balance moment, may be associated with the unique identifier assigned to each respective rotor blade. This data may be input into a computer system/device communicatively coupled to the controller 310 for use by the controller 310 in controlling the robot 300 during subsequent processing. For example, the rotor blades in the batch may be weighed and returned to the processing chamber to complete the remaining deposition of protective material layers. The data associated with weighing each respective blade may be used by the robot 300 to direct the thermal sprayer 320 to desired portions of the respective rotor blade to add protective material. Based on the data generated from weighing, the controller 310 may control the robot 300 to omit depositing layers on some rotor blades, deposit additional layers to some rotor blades, deposit layers to specific portions of some rotor blades, such as to the tip of the rotor blade only, and/or perform any other thermal spraying application desired to properly balance the rotor blade while simultaneously depositing the desired thickness of protective material. By weighing the rotor blades at a point during processing, rather than only before and/or after complete application of the protective material, the rotor blades may be properly balanced within tolerance by the remaining deposition of protective material while remaining within the allowable contour tolerances. This may reduce costs associated with properly balancing rotor blades and/or increase the number of rotor blades capable of being processed.

In some embodiments, it may be desired to have differing thicknesses of protective material on specific locations of the rotor blade. For example, the rotor blade may experience more erosive effect at the leading edge and/or the tip of the rotor blade where the impingement velocity and/or impingement angle of the erosive debris may be the most detrimental. Therefore, within embodiments, the robot 300 may be controlled to deposit, via the thermal sprayer 320, non-uniform thicknesses of protective material onto specified locations of the rotor blades. For example, as illustrated by the thickness 220A on the leading edge 208 and the thickness 220B on the upper contour 212, the robot 300 may be controlled to deposit, using the thermal sprayer 320, more layers of protective material onto a portion of the tip and/or a portion of the leading edge than compared to at a portion proximate to the root and or a distance from the leading edge, such as at 25% chord length. Thus, based on design needs the robot 300 may be controlled to allow for thicker protective material to be applied to specific locations of the rotor blade, and/or thinner protective material to be applied to specific locations of the rotor blade, by adjusting the number of layers applied to the respective portion of the rotor blade. This may allow for rotor blades to be lighter in weight compared to conventional methods of applying protective material, while still providing adequate protection against erosive effects.

Within embodiments, the robot 300 may be used to repair the protective material on rotor blades that have been used in service and may have experienced damage to the protective material. For example, used rotor blades may undergo examination, such as by undergoing a three-dimensional digital scan, to determine areas on the rotor blade where the protective material may be worn and/or damaged (e.g., eroded) during service in the field. In some examples, the three-dimensional scan may be a white light scan and/or an ultrasonic scan. The data associated with the areas determined to be damaged and/or worn may be used by the controller 310 to control the robot 300 in depositing protective material on the damaged areas of the rotor blade. For instance, the robot 300 may be controlled to direct the thermal sprayer 320 to specific locations on the rotor blade where repair may be desired, while avoiding depositing protective material on other locations of the rotor blade. In controlling the robot 300 to repair the rotor blade by selectively depositing protective material at the damaged locations, the rotor blade may be returned to operable conditions without the need to remove and replace the entire protective material from the rotor blade. This may reduce damage to the rotor blade that may occur as a result of removing the entire protective material, and/or may decrease downtime of the rotor blade from service. Thus, selective deposition of protective material, via thermal spraying, based on determined areas of damage may reduce costs associated with repairing the rotor blade by decreasing overhaul downtime and/or decreasing scrap rate of the rotor blades. In some embodiments, the rotor blade may be weighed prior to, during, and/or after application of the protective material to the damaged areas. As previously stated, the weight may be used to determine the center of gravity and/or the span balance moment, against the master rotor blade, in order to properly balance the rotor blade undergoing repair. This may be used to determine the thickness of protective material to be applied at the respective repair locations on the rotor blade to balance the rotor blade in the final repaired state.

In some embodiments the thermal sprayer 320 may apply the protective material using high-velocity oxygen fuel (HVOF), high-velocity air fuel (HVAF), air plasma spraying, combustion wire and powder spraying, twin wire arc spraying, spray and fuse hardening, cold gas dynamic spraying (CGDS), or any other thermal spraying technique used by those having skill in the art. While application of the protective material is described using the thermal sprayer 320, other methods and processes of application may be used.

While the above description pertains to application of protective material onto rotor blades, the embodiments described with respect to FIG. 3 may be used to apply materials to other components as well, such as any structural or non-structural part of a vehicle where a protective material may be desired.

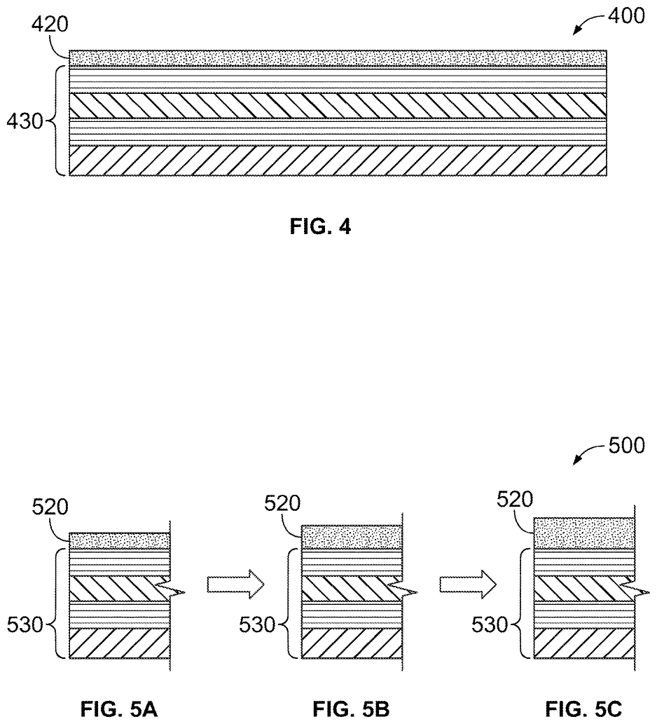

FIG. 4 is a cross-sectional view of a portion of a rotor blade 400, according to exemplary embodiments of the present invention. In the embodiment shown, the portion of the rotor blade 400 includes a composite laminate 430 having a protective material 420 bonded to a surface of the composite laminate 430. The portion of the rotor blade 400 shown in FIG. 4 may be a portion of the rotor blade 100 and 200 shown and described in FIG. 1 and/or FIGS. 2A-2B.

The composite laminate 430 in example embodiments may be a structural member of the rotor blade designed to carry load throughout the rotor blade. The composite laminate 430 may have an airfoil cross-sectional shape and may act as a lift or thrust producing surface. In some embodiments, the composite laminate 430 may include multiple types of fibers (e.g., aramid, carbon, glass), weave or no weave patterns (e.g., chopped, unidirectional, plain weave, 2×2 twill weave, 4×4 twill weave, 5 harness, 8 harness), and/or matrices (e.g., metal matrix; thermoplastic and/or thermoset polymer matrix, such as, epoxies). The composite laminate 430 may further vary in the number of plies used, the specific ratio of fiber to matrix, and the orientation of the respective plies.

In the example embodiment shown, the protective material 420 may be bonded directly to an outer surface of the composite laminate 430. This may be accomplished via thermal spraying the protective material 420 directly onto the outer surface of the composite laminate 430, as described in FIG. 3. While FIG. 4 illustrates the protective material 420 situated on one outer surface of the composite laminate 430, the protective material may be located on any surface of the composite laminate 430. In some embodiments, the selection of a top or bottom ply of the composite laminate 430 may be based on bondability with the protective material 420. For instance, in examples where the protective material 420 may be thermally sprayed onto the composite laminate 430, the top and/or bottom ply may be selected to promote bonding of the protective material 420 to the composite laminate 430. For example, the top and/or bottom ply may be a prepreg having a metallic particle impregnated matrix.

While the protective material 420 shown in the embodiment of FIG. 4 may have a uniform thickness across the composite laminate 430, in other embodiments the thickness of the protective material 420 may be non-uniform.

FIGS. 5A-5C are cross-sectional portions of a rotor blade 500 showing a protective material 520 at different stages of processing, according to exemplary embodiments of the present invention. During processing one or more layers of protective material 520 may be applied, via thermal spraying, to a composite laminate 530 of the rotor blade 500. Thermal spraying may increase the temperature of the composite laminate 530. Within embodiments, the rotor blade 500 may be cooled between application of each respective layer of protective material 520 to reduce the temperature of the composite laminate 530. In some embodiments, cooling may be performed by forced and/or natural convective cooling. Cooling the rotor blade 500 between application of each respective layer of protective material 520 may mitigate material properties of the composite laminate 530 from becoming adversely affected.

Each cross-sectional portion of the rotor blade 500 shows the protective material 520 after successive application of additional layers by the thermal sprayer. In some examples, the first cross-sectional portion in FIG. 5A may show the protective material 520 after ten layers have been thermally sprayed onto the composite laminate 530, the second cross-sectional portion in FIG. 5B may show the protective material 520 after twenty layers have been thermally sprayed onto the composite laminate 530, and the third cross-sectional portion in FIG. 5C may show the protective material 520 after thirty layers have been thermally sprayed onto the composite laminate 530. As can be seen in the embodiments of FIGS. 5A-5C, each cross-sectional portion of the rotor blade 500 shows the protective material 520 as uniform (e.g, homogenous) as additional layers may be applied. Thus, in some embodiments, the parameters used in thermal spraying the protective material 520, may cause each subsequent layer to fuse (become one homogenous layer) with the prior applied layer to form a single homogenous layer of protective material 520. Thus, in some embodiments, the term “layers” as used herein refers to a number of thermal spraying operations performed on the rotor blade 500. By forming the single layer of protective material 520, peeling of the protective material 520 may be reduced and the rotor blade 500 may be better protected in operation.

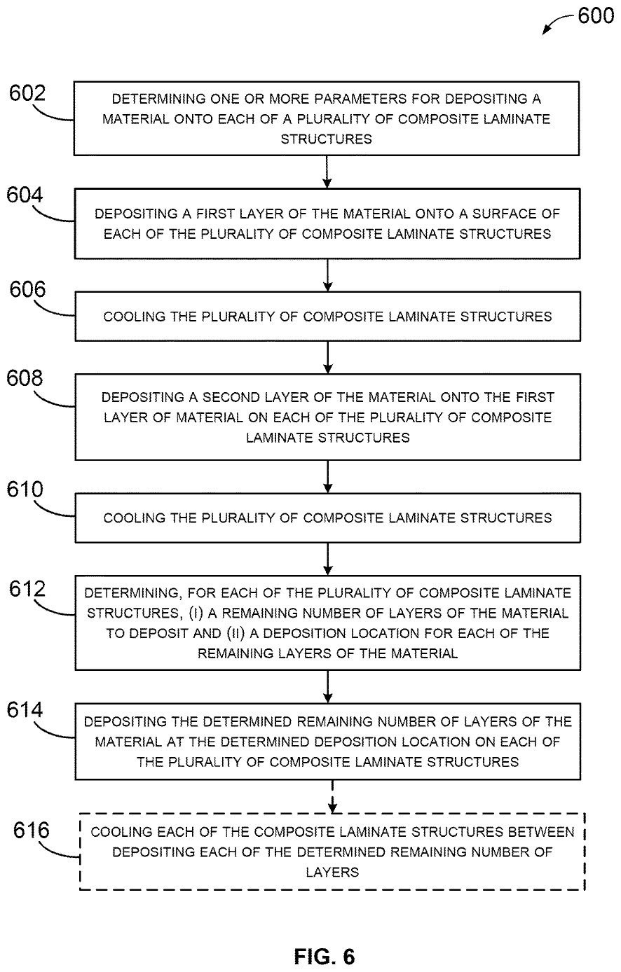

FIG. 6 is a flow chart of an example method 600 for adding protective material to a composite laminate, according to exemplary embodiments of the present invention. The method 600 may be performed by the robot 300 in FIG. 3, for example. The method 600 may include one or more operations, or actions as illustrated by one or more steps 602-614. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

As illustrated, at step 602, the method 600 may include determining one or more parameters for depositing a material onto each of a plurality of composite laminate structures.

At step 604 the method 600 may include depositing a first layer of the material onto a surface of each of the plurality of composite laminate structures.

At step 606 the method 600 may include cooling the plurality of composite laminate structures. Within embodiments, the plurality of composite laminate structures may be cooled subsequent to depositing the first layer of the material.

At step 608 the method 600 may include depositing a second layer of the material onto the first layer of material on each of the plurality of composite laminate structures.

At step 610 the method 600 may include cooling the plurality of composite laminate structures. Within embodiments, the plurality of composite laminate structures may be cooled subsequent to depositing the second layer of the material.

At step 612 the method 600 may include determining, for each of the plurality of composite laminate structures, (i) a remaining number of layers of the material to deposit and (ii) a deposition location for each of the remaining layers of the material.

At step 614 the method 600 may include depositing the determined remaining number of layers of the material at the determined deposition location on each of the plurality of composite laminate structures.

In some embodiments, the method 600 may include step 616 of cooling each of the composite laminate structures between depositing each of the determined remaining number of layers.

In some embodiments, the plurality of composite laminate structures may be rotor blades.

In some embodiments, determining, for each of the plurality of composite laminate structures, (i) the remaining number of layers of the material to deposit and (ii) the deposition location for each of the remaining layers of the material may be based on a weight and a spanwise weight distribution of each of the plurality of composite laminate structures.

In some embodiments, each of the determined remaining number of layers of material is sequentially deposited onto each of the plurality of composite laminate structures.

In some embodiments, the plurality of composite laminate structures are fan blades for a turboprop engine.

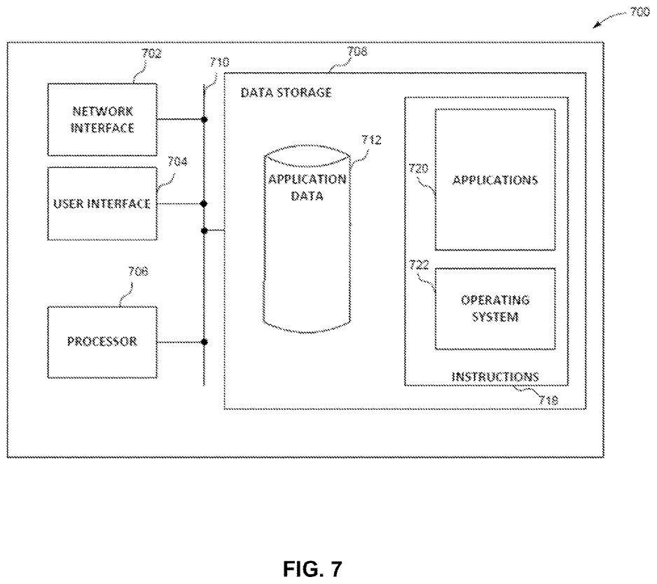

FIG. 7 is a simplified block diagram showing some of the components of an example computing device 700, according to an exemplary embodiment of the present disclosure. In some embodiments, a control panel and/or a controller (e.g., the controller 310 shown and described with reference to FIG. 3) may include the computing device 700. In other examples, the computing device 700 may be communicatively coupled to the controller (e.g., the controller 310). The computing device 700 may correspond to a computing device configured to perform additional functions (e.g., in communication with one or more other computing devices using a web browser and/or an application). In various embodiments, the computing device 700 may be a mobile computing device (e.g., a smartphone), a desktop computing device, a laptop computing device, a tablet computing device, or a wearable computing device (e.g., a smartwatch or a smart wristband). As illustrated in FIG. 7, the computing device 700 may include a network interface 702, a user interface 704, a processor 706, and data storage 708. The network interface 702, the user interface 704, the processor 706, and/or the data storage 708 may be communicatively linked together by a bus 710 (e.g., an electrical interconnect defined on one or more printed circuit boards).

The network interface 702 may be used by the computing device 700 to communicate with other computing devices over one or more networks (e.g., the public Internet). In some embodiments, the network interface 702 may include a wired interface (e.g., Ethernet). Additionally or alternatively, the network interface 702 may include a wireless interface, such as WIFI. Other interfaces may be included in the network interface 702 and are contemplated herein.

The user interface 704 may function to allow computing device 700 to receive input from and/or provide output to a user. As such, the user interface 704 may include inputs (e.g., a keypad, a keyboard, a touch-screen, a computer mouse, a microphone, a microphone jack, etc.) and/or outputs (e.g., a cathode-ray tube (CRT) display, a liquid-crystal display (LCD), a light-emitting diode (LED) display, a speaker, a speaker jack, headphones, a headphone jack, etc.).

The processor 706 may include one or more general purpose processors (e.g., microprocessors) and/or one or more special-purpose processors (e.g., graphics processing units (GPUs) or application-specific integrated circuits (ASICs)). In some embodiments, for example, the processor 706 may include special-purpose processors capable of generating a machine-learned model and/or using a machine-learned model to perform analyses as described herein.

The data storage 708 may include one or more volatile and/or non-volatile memories. For example, the data storage may include a RAM, a ROM, a hard drive, a solid state drive, etc. In some embodiments, the data storage 708 may be partially or wholly integrated with the processor 706 (e.g., a level 1 (L1) cache or a level 2 (L2) cache within a central processing unit). The data storage 708 may include removable components (e.g., a flash drive) and/or non-removable components (e.g., a ROM integrated with a motherboard).

The processor 706 may be configured to execute instructions 718 (e.g., compiled or non-compiled program logic and/or machine code) stored in the data storage 708 to carry out the methods described herein. Hence, the data storage 708 may include a non-transitory computer-readable medium, having stored thereon program instructions that, when executed by the processor 706, cause the processor 706 to carry out any of the methods, processes, or operations disclosed in this specification and/or the accompanying drawings. In some embodiments, the processor 706 may use the application data 712 while executing the instructions 718.

In some embodiments, the instructions 718 may include an operating system 722 (e.g., an operating system kernel, device driver(s), and/or other modules) and one or more applications 720 (e.g., mobile applications, sometimes referred to as “apps”). As described above, the processor 706 may access the application data 712 when executing the applications 720.

The applications 720 may communicate with the operating system 722 through one or more application programming interfaces (APIs). These APIs may facilitate, for instance, the applications 720 reading and/or writing the application data 712, transmitting or receiving information via the network interface 702, receiving and/or displaying information on the user interface 704, etc.

Additionally, the applications 720 may be downloadable to the computing device 700 through one or more online application stores or application markets (e.g., using the network interface 702). However, application programs can also be installed on the computing device 700 in other ways, such as via a web browser or through a physical interface (e.g., a universal serial bus (USB) port) on the computing device 700.

While many of the techniques and functions described herein may be performed by the processor 706 executing one of the applications 720, it understood that other ways for the computing device 700 to perform such techniques and functions are also possible and are contemplated herein. For example, some or all of the calculations may be performed remotely (e.g., on a server computing device). Such an embodiment may be referred to as a “browser-based app” when the computing device 700 provides data (e.g., application data 712) to a different computing device for analysis using a web browser. Additionally or alternatively, such an interaction between the computing device 700 and another computing device may be performed using an API or a browser-based language (e.g., JavaScript).

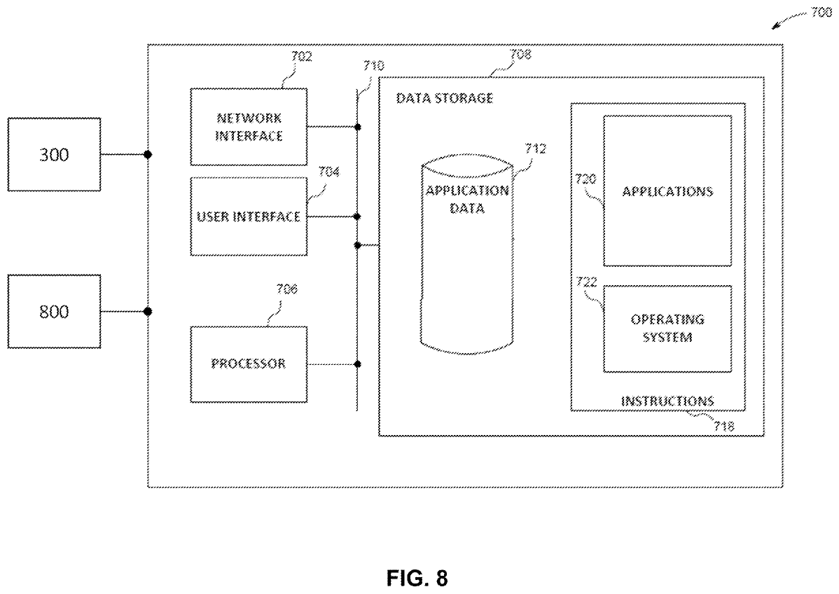

FIG. 8 is a block diagram showing the computing device 700 coupled to the robot 300 and a plurality of rotor blades 800; according to exemplary embodiments of the present invention. The computing device 700 may control one or more operations during processing of the plurality of rotor blades 800. For example, the computing device 700 may control one or more parameters for depositing a material, using a thermal sprayer coupled to the robot 300, onto each of the plurality of rotor blades 800. For example, the computing device 700 may control a deposition material(s), a deposition time, a deposition temperature, a deposition velocity, and/or a deposition location. The computing device 700 may control the robot 300 to deposit, using the thermal sprayer, one or more layers of the material onto a surface of each of the plurality of rotor blades 800.

For example, the computing device 700 may control the robot 300 to deposit a first layer of material along a portion of each of the plurality of rotor blades. The robot 300 may be directed, via the computing device 700, to deposit the first layer of material along a portion of a first rotor blade of the plurality of rotor blades 800. In some examples, the first rotor blade may remain static and the robot 300 may be controlled to move about the first rotor blade to direct the thermal sprayer to desired locations on the first rotor blade for deposition. However, in other examples, the first rotor blade may additionally and/or alternatively be controlled by the computing device 700 to move such that the thermal sprayer may deposit material onto determined locations. After depositing the first layer onto the first rotor blade, the computing device 700 may direct the robot 300 to begin deposition of a first layer of material onto a second rotor blade of the plurality of rotor blades 800. The first rotor blade may begin cooling during deposition of the first layer on the second rotor blade. After depositing the first layer onto the second rotor blade, the robot 300 may be directed by the computing device 700 to deposit a first layer of material onto a third rotor blade of the plurality of rotor blades 800. The first and second rotor blades may cool during deposition of the first layer on the second rotor blade. The deposition process of the first layer of material outlined above may be repeated for all rotor blades of the plurality of rotor blades 800.

In some examples, the plurality of rotor blades 800 may be represented by n. In such examples, after the first layer of material has been deposited on the n^{th} rotor blade, the first rotor blade may have undergone cooling to below a determined temperature such that the robot 300 may be controlled by the computing device 700 to begin deposition of a second layer of material onto the first rotor blade. The process may thus be repeated until the determined number of layers of material have been deposited onto each of the plurality of rotor blades 800.

Implementations of the present disclosure can thus relate to one of the example embodiments listed below.

Embodiment 1 is a method comprising: determining one or more parameters for depositing a material, using a thermal sprayer, onto each of a plurality of composite laminate structures; depositing, using the thermal sprayer, a first layer of the material onto a surface of each of the plurality of composite laminate structures; cooling, subsequent to depositing the first layer of the material, the plurality of composite laminate structures; depositing, using the thermal sprayer, a second layer of the material onto the first layer of material on each of the plurality of composite laminate structures; cooling, subsequent to depositing the second layer of the material, the plurality of composite laminate structures; determining, for each of the plurality of composite laminate structures, (i) a remaining number of layers of the material to deposit and (ii) a deposition location for each of the remaining layers of the material; and depositing, using the thermal sprayer, the determined remaining number of layers of the material at the determined deposition location on each of the plurality of composite laminate structures.

Embodiment 2 is the method according to embodiment 1, wherein the plurality of composite laminate structures are rotor blades.

Embodiment 3 is the method according to embodiment 1 or embodiment 2, wherein a portion of each of the plurality of rotor blades comprises a bond promoting layer.

Embodiment 4 is the method according to any of embodiments 1 to 3, wherein determining, for each of the plurality of composite laminate structures, (i) the remaining number of layers of the material to deposit and (ii) the deposition location for each of the remaining layers of the material is based on a weight and a spanwise weight distribution of each of the plurality of composite laminate structures.

Embodiment 5 is the method according to any of embodiments 1 to 4, wherein each of the determined remaining number of layers of material is sequentially deposited onto each of the plurality of composite laminate structures.

Embodiment 6 is the method according to any of embodiments 1 to 5, wherein depositing, using the thermal sprayer, the determined remaining number of layers of the material at the determined deposition location on each of the plurality of composite laminate structures further comprises cooling each of the composite laminate structures between depositing each of the determined remaining number of layers.

Embodiment 7 is the method according to any of embodiments 1 to 6, wherein the plurality of composite laminate structures are fan blades for a turboprop engine.

Embodiment 8 is the method according to any of embodiments 1 to 7, wherein determining the one or more parameters for depositing the material further comprises examining, using a three-dimensional digital scan, existing deposited material on at least one of the plurality of composite laminate structures.

Embodiment 9 is the method according to any of embodiments 1 to 8, wherein the thermal sprayer is coupled to a robot, and depositing the first layer of the material comprises directing the thermal sprayer, using the robot, along a determined deposition location of each of the plurality of composite laminate structures.

Embodiment 10 is the method according to any of embodiments 1 to 9, wherein the deposition location of at least one of the remaining layers of material is different than a deposition location of the first layer.

Embodiment 11 is the method according to any of embodiments 1 to 10, wherein a thickness of deposited material at a first location on each of the plurality of composite laminate structures is different than a thickness of deposited material at a second location.

Embodiment 12 is the method according to any of embodiments 1 to 11, wherein depositing the first layer of material onto the surface of each of the plurality of composite laminate structures further comprises: depositing the first layer of material onto the surface of a first composite laminate structure; and subsequent depositing the first layer of material onto the surface of a first composite laminate structure to the first composite laminate structure, depositing the first layer of material onto the surface of a second composite laminate structure.

Embodiment 13 is the method according to any of embodiments 1 to 12, wherein cooling the plurality of composite laminate structures further comprises cooling the first composite laminate structure during deposition of the first layer onto the second composite laminate structure.

Embodiment 14 is the method according to any of embodiments 1 to 13, wherein the plurality of composite laminate structures are mounted on a rack or a carousel.

Embodiment 15 is the method according to any of embodiments 1 to 14, wherein each of the plurality of composite laminate structures is assigned a unique identifier and the method further comprises associating, for each of the plurality of composite laminate structures, (i) the determined remaining number of layers of material to deposit and (ii) the determined the deposition location for each of the remaining layers of the material with the unique identifier.

Embodiment 16 is the method according to any of embodiments 1 to 15, wherein depositing the first layer of material comprises depositing a material comprising at least 90 percent nickel in direct communication with a surface of the composite laminate structure.

Embodiment 17 is the method according to any of embodiments 1 to 16, wherein the remaining number of layers of the material to deposit on a first composite laminate structure is different than the remaining number of layers of the material to deposit on a second composite laminate structure.

Embodiment 18 is a non-transitory computer readable medium comprising program instructions executable by one or more processors to perform the operations comprising: determining one or more parameters for depositing a material, using a thermal sprayer, onto each of a plurality of composite laminate structures; depositing, using the thermal sprayer, a first layer of the material onto a surface of each of the plurality of composite laminate structures; cooling, subsequent to depositing the first layer of the material, the plurality of composite laminate structures; depositing, using the thermal sprayer, a second layer of the material onto the first layer of material on each of the plurality of composite laminate structures; cooling, subsequent to depositing the second layer of the material, the plurality of composite laminate structures; determining, for each of the plurality of composite laminate structures, (i) a remaining number of layers of the material to deposit and (ii) a deposition location for each of the remaining layers of the material; and depositing, using the thermal sprayer, the determined remaining number of layers of the material at the determined deposition location on each of the plurality of composite laminate structures.

Embodiment 19 is a rotor blade comprising: a composite laminate structure; and a protective material comprising at least 90 percent nickel in direct communication with a surface of the composite laminate structure and disposed along a leading edge of the rotor blade, the protective material having a non-constant thickness.

Embodiment 20 is a robot for thermally spraying material onto composite laminate structures, the robot comprising: a thermal sprayer; and a controller operably connected to the robot and configured to cause the robot to selectively deposit, using the thermal sprayer, one or more layers of a material onto a specified location on each of a plurality of composite laminate structures.

While the disclosure discusses application of protective materials on rotor blades, the above processes, methods, and devices may be used on any structural and/or non-structural part where application of protective material may be desired.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Further, one or more example features and/or implementations described with respect to a figure may be combinable with one or more example features and/or implementations described with respect another figure and/or figures. Thus, the example features and/or implementations described in each of the figures are not meant to be taken in isolation but may be combinable with any other example feature and/or implementation described above. For example, one or more example features and/or implementations described in any of FIGS. 1-8 may be combinable with one or more example features and/or implementations described in another figure. Further, unless context suggests otherwise, some but not all of the features and/or implementations illustrated in each of the figures may be used in combination with one another.

What is claimed is:

1. A method comprising:
determining one or more parameters for depositing a material, using a thermal sprayer, onto each of a plurality of composite laminate structures;
depositing, using the thermal sprayer, a first layer of the material onto a surface of each of the plurality of composite laminate structures;
cooling, subsequent to depositing the first layer of the material, the plurality of composite laminate structures;
depositing, using the thermal sprayer, a second layer of the material onto the first layer of material on each of the plurality of composite laminate structures;
cooling, subsequent to depositing the second layer of the material, the plurality of composite laminate structures;
determining, for each of the plurality of composite laminate structures, (i) a remaining number of layers of the material to deposit and (ii) a deposition location for each of the remaining layers of the material; and
depositing, using the thermal sprayer, the determined remaining number of layers of the material at the determined deposition location on each of the plurality of composite laminate structures.

2. The method of claim 1, wherein the plurality of composite laminate structures are rotor blades.

3. The method of claim 2, wherein a portion of each of the plurality of rotor blades comprises a bond promoting layer.

4. The method of claim 1, wherein determining, for each of the plurality of composite laminate structures, (i) the remaining number of layers of the material to deposit and (ii) the deposition location for each of the remaining layers of the material is based on a weight and a spanwise weight distribution of each of the plurality of composite laminate structures.

5. The method of claim 1, wherein each of the determined remaining number of layers of material is sequentially deposited onto each of the plurality of composite laminate structures.

6. The method of claim 1, wherein depositing, using the thermal sprayer, the determined remaining number of layers of the material at the determined deposition location on each of the plurality of composite laminate structures further comprises:
cooling each of the composite laminate structures between depositing each of the determined remaining number of layers.

7. The method of claim 1, wherein the plurality of composite laminate structures are fan blades for a turboprop engine.

8. The method of claim 1, wherein determining the one or more parameters for depositing the material further comprises examining, using a three-dimensional digital scan, existing deposited material on at least one of the plurality of composite laminate structures.

9. The method of claim 1, wherein the thermal sprayer is coupled to a robot, and depositing the first layer of the material comprises directing the thermal sprayer, using the robot, along a determined deposition location of each of the plurality of composite laminate structures.

10. The method of claim 1, wherein the deposition location of at least one of the remaining layers of material is different than a deposition location of the first layer.

11. The method of claim 1, wherein a thickness of deposited material at a first location on each of the plurality of composite laminate structures is different than a thickness of deposited material at a second location.

12. The method of claim 1, wherein depositing the first layer of material onto the surface of each of the plurality of composite laminate structures further comprises:
depositing the first layer of material onto the surface of a first composite laminate structure; and
subsequent depositing the first layer of material onto the surface of a first composite laminate structure to the first composite laminate structure, depositing the first layer of material onto the surface of a second composite laminate structure.

13. The method of claim 12, wherein cooling the plurality of composite laminate structures further comprises cooling the first composite laminate structure during deposition of the first layer onto the second composite laminate structure.

14. The method of claim 1, wherein the plurality of composite laminate structures are mounted on a rack or a carousel.

15. The method of claim 1, wherein each of the plurality of composite laminate structures is assigned a unique identifier and the method further comprises:
associating, for each of the plurality of composite laminate structures, (i) the determined remaining number of layers of material to deposit and (ii) the determined the deposition location for each of the remaining layers of the material with the unique identifier.

16. The method of claim 1, wherein depositing the first layer of material comprises depositing a material comprising at least 90 percent nickel in direct communication with a surface of the composite laminate structure.

17. The method of claim 1, wherein the remaining number of layers of the material to deposit on a first composite laminate structure is different than the remaining number of layers of the material to deposit on a second composite laminate structure.

18. A non-transitory computer readable medium comprising program instructions executable by one or more processors to perform the operations comprising:
determining one or more parameters for depositing a material, using a thermal sprayer, onto each of a plurality of composite laminate structures;
depositing, using the thermal sprayer, a first layer of the material onto a surface of each of the plurality of composite laminate structures;
cooling, subsequent to depositing the first layer of the material, the plurality of composite laminate structures;
depositing, using the thermal sprayer, a second layer of the material onto the first layer of material on each of the plurality of composite laminate structures;
cooling, subsequent to depositing the second layer of the material, the plurality of composite laminate structures;
determining, for each of the plurality of composite laminate structures, (i) a remaining number of layers of the material to deposit and (ii) a deposition location for each of the remaining layers of the material; and
depositing, using the thermal sprayer, the determined remaining number of layers of the material at the determined deposition location on each of the plurality of composite laminate structures.

19. A rotor blade comprising:
a composite laminate structure; and
a protective material comprising at least 90 percent nickel in direct communication with a surface of the composite laminate structure and disposed along a leading edge of the rotor blade, the protective material having a non-constant thickness.

20. A robot for thermally spraying material onto composite laminate structures, the robot comprising:
a thermal sprayer; and
a controller operably connected to the robot and configured to cause the robot to selectively deposit, using the thermal sprayer, one or more layers of a material onto a specified location on each of a plurality of composite laminate structures.
